(19) United States
(12) Patent Application Publication
(10) Pub. No.: US 2003/0023620 A1
(43) Pub. Date: Jan. 30, 2003

(54) Creation of media-interaction profiles

(76) Inventor: Nicholas Trotta, San Francisco, CA (US)

Correspondence Address: PILLSBURY WINTHROP LLP, 1600 Tysons Boulevard, McLean, VA, 22102, US

(21) Appl. No.: 09/919,573

(22) Filed: Jul. 30, 2001

(51) Int. Cl. G06F 12/00

(52) U.S. Cl. 707/203

(57) ABSTRACT

A client side transaction collection system is able to interface with applications that users use to interact (play, access, organize, find, or share) with local media such as video and audio files. This transaction collection system contains pieces for interacting the applications and a single module for managing the push of collected transactions to an external system.

A server-side system is able to take from client software, website systems, or external collection systems information about user interaction with media (play, access, organize, finding, or sharing). This system is able to take the collected information and use it to update an extremely rich user profile describing past user interactions in a useful form. The process for this involves detailed archival of information, recognition of target media, updates to rolling recent activity information, and additions to aggregated interest data based on affected categories.

### BACKGROUND OF THE INVENTION

1. Field of the Invention

The present invention is directed to information processing systems. More particularly, the invention is directed to systems that are able to collect detailed information about users' interactions with digital video and audio media for purposes of later personalization and content targeting.

2. Background of the Related Art

Various services exist that ask service users to pick, choose, and rate all of their favorite movies or artists through a web-based or local interface. Services of this type require user entry in such a fashion as to exactly determine a user's interest with respect to single items in a large media catalog.

The basis for collection for these services is direct input from users. The user profiles that these services build reflect recorded likes and/or dislikes of users based on their explicitly provided preferences.

In addition, there are a number of applications that allow users to interact with video and audio media on their local or remote machines. Such applications often have features that allow users to access, play, share, organize, and find such media.

There is no service in the prior art that is able to plug in to virtually any type of external media application for the sole purpose of capturing user interactions and reporting them to a central server system where they are aggregated in such a fashion as to accurately and usefully represent user interest level with respect to individual points in various categories of media.

### SUMMARY OF THE INVENTION

A client side transaction collection system interfaces with applications that users use to interact (play, access, organize, find, or share) with local media such as video and audio files. This transaction collection system contains pieces for interacting the applications and a single module for managing the push of collected transactions to an external system. A server-side system takes from client software, website systems, or external collection systems information about users' interaction with media (play, access, organize, finding, or sharing). This system takes the collected information and uses it to update an extremely rich user profile describing past user interactions in a useful form. The process for this involves detailed archival of information, recognition of target media, updates to rolling recent activity information, and additions to aggregated interest data based on affected categories.

### BRIEF DESCRIPTION OF THE DRAWINGS

These and other aspects of an embodiment of the present invention are better understood by reading the following detailed description of the preferred embodiment, taken in conjunction with the accompanying drawings, in which:

FIG. 1 is a flowchart of a message moving through a media interaction stub in the embodiment;

FIG. 2 is a flowchart of a message being received by the Messenger module in the embodiment;

FIG. 3 is a flowchart of a messages being pushed to the server by the Messenger in the embodiment;

FIG. 4 is a flowchart of server operations for profile building in the embodiment;

FIG. 5 is a flowchart of transaction archival operations in the embodiment, and

FIG. 6 is a flowchart of media identification operations in the embodiment.

### DETAILED DESCRIPTION OF EXEMPLARY EMBODIMENT

The present invention provides an architecture and methodology for capturing detailed data about the way in which users of personal computers interact with media. Examples of interaction with media include, for example, capturing that a user has changed the current playing state of a digital media file (beginning to play a song with an MP3 software, for instance) or has paused video playback of an MPEG movie. The full data flow for this process entails independent distinct pieces. The first independent piece is a full client architecture for monitoring the state of media-playing applications and pushing those states to a server. The second independent piece is server-based, detailing how a server system can take detailed information about user behavior and apply it to a rich user profile for later use.

The two types of components in the client architecture are the “Messenger” (a single module responsible for interfacing with server systems) and “Media Activity Stubs” (multiple modules responsible for sending user interaction information to the Messenger).

The Media Activity Stub components can be independent executable programs, application-specific plug-ins, COM object shims, or plug-in specific for the Messenger. Their sole purpose is to detect state changes within applications that provide the user control to play, access, or share digital video or audio media.

An example of an independent executable manifestation would be a stub made for monitoring user activity with a file-sharing application. This executable program would be started and would proceed to look for new media files appearing in a user's download directory, thereby capturing information about user interaction with media through the file-sharing application, specifically capturing events where users download files.

An example of an application-specific plug-in would be a stub made to interface with an MP3 media player that had it's own plug-in architecture whereby a Microsoft Windows DLL can be written to be loaded by the application at startup. After loading, the code in the library can access the state of the media player through API calls. Since these API calls include the ability to query for playing state and media, the stub now has full access to information about what media users are playing with the application.

An example of a COM object shim would be a stub made for monitoring the activity of a Microsoft Windows control that be used to play media from ActiveX controls embedded in a browser to stream video content. Such a shim would register itself in the Windows registry with the same COM GUID as the control it wished to monitor, thereby replacing the control when instantiated from within the ActiveX control in the browser. After instantiation, the control would instantiate the actual media playing control and subsequently pass through all method calls while monitoring what the calls were doing. Therefore, when a page in the user's browser uses the ActiveX wrapper for the video playing control to stream a movie, the stub would know that this call had been made and therefore has full access to information about what media users are streaming in their browser.

An example of a plug-in specific for the Messenger would be a stub designed to monitor a block of description text displayed in a Windows control within a local video playing application. In order to do this, this stub would be written as a plug-in for the Messenger such that starting the Messenger would load the library for the plug-in and initialize it. From this point forward, the running library code would poll to see if the video playing application to be monitored had been started and was currently running. If it detects that the application is running, it will hook the application via the standard Windows hook procedure calls so as to facilitate access to Windows controls within the application space as if it was accessing those controls from inside the same process. By using this mechanism the stub can then access the descriptive text with the name of the currently playing local video file. By doing this, the stub has full access to information about what video media users are playing off of their local machine.

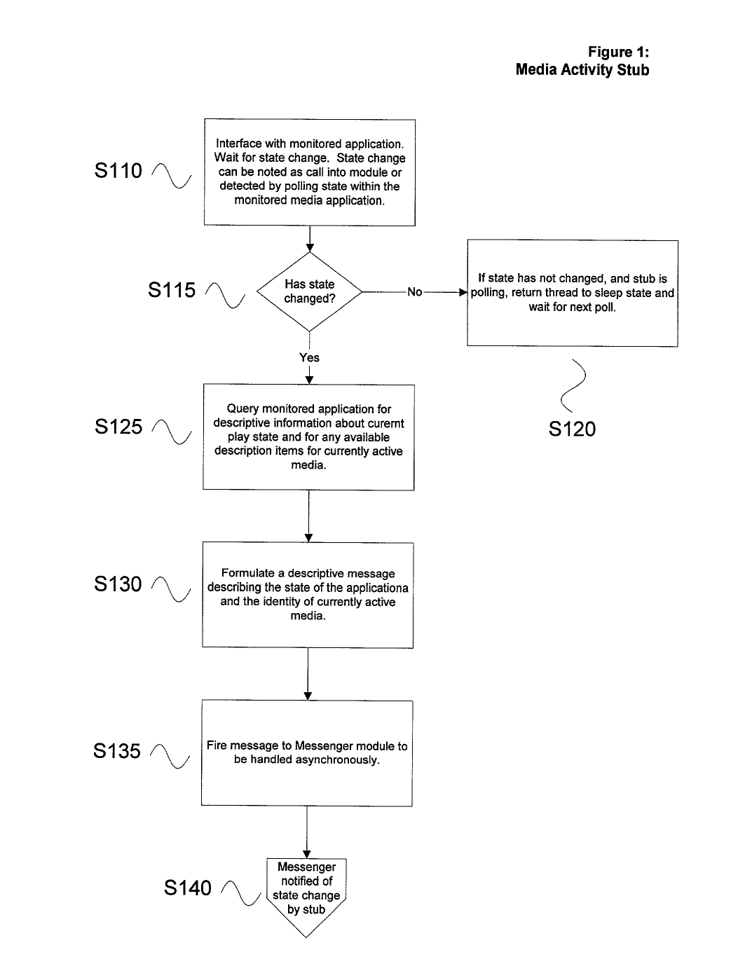

Regardless of the nature of the stub (executable program, external plug-in, control shim, or plug-in for the Messenger) the executing code within the stub fundamentally has the same function. That function is to interface with a media-related application on the user's machine, capture state-change information from the application that relates to user interaction with media (FIG. 1, S125), wrap that information up into a standardized message format, and pass this information to the Messenger module (S110).

Examples of media-interaction events for two types of media (video and audio) include:

Download of a new media file by the user's local computer from an external source.

The creation of a new media file on the user's local computer.

The deletion of a media file that existed on the user's local computer

The movement (copying) of a media file on the user's local computer.

The change (creation, addition, modification, deletion) of a playlist: a set of transition information for the playing of media files.

The start of playback of a local media file or streamed media file by the user's machine.

The stopping or end of playback of a local media file or streamed media file by the user's machine.

The pause of playback of a local media file or streamed media file by the user's machine.

When any of these types of media-interaction events are detected (S115, S120), the media activity stub will send a message to the Messenger via a standard communication mechanism (S135, S140). Examples of inner-process or intra-process communication mechanisms for Windows include the posting of a Windows message, or opening a socket and pushing a data message through it. The details of this message are formatted in XML or any other standard format mechanism (S130). This vocabulary for this communication mechanism is shared across all stubs. Some stubs may not utilize the full vocabulary, and the message format is such that additional vocabulary can be added at any time without invalidating the existing message formats: an XML-based vocabulary facilitates this. The vocabulary is designed to pass all captured information specific to the captured media-interaction event. Such vocabulary would include the ability to pass information related to:

A transaction type identifier.

The full local location of a media file.

The full external location locator (could be URL) to a media file.

The type and format of media file.

The total play length of the media file

The playback state of the monitored application.

Identifying meta-information or tags specific to the media format identifying the content of the media file.

The identity of the monitored application.

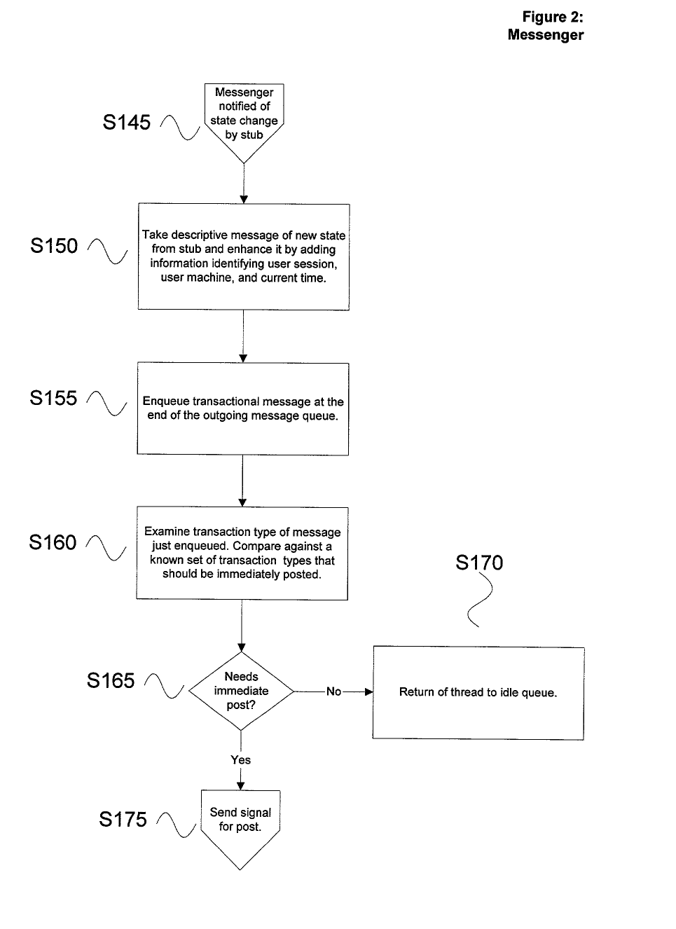

The Messenger module takes over after being handed off a transaction from a media activity stub (FIG. 2, S145). This module is a standalone executable program on the user's desktop. It functions as the sole external network interface for pushing captured information about user interaction with media up to the server. The Messenger maintains some state information that is transparent to the media activity stubs. This includes information identifying the current user, information identifying the user's machine, and timing information (S150).

For identifying the current user, the Messenger module is passed a unique identifier string that the server systems that have associated with a user's session. This identifier is set by way of a special response transaction that the Messenger module will look for in the return value set of any posted HTTP communication. Such a transaction will tell the module the string identifier for the unique user and the Messenger module will note that persistently, until such time as another such identification transaction arrives from the server and changes the user identifier.

For identifying the user's system, the Messenger module is passed a unique identifier string that the server systems have associated with the user's system. This identifier is set by way of a parameter set on the initial installation of the Messenger and is stored persistently on the user's machine. After being set, this parameter will remain the same for the lifetime of the user's software installation.

When passed transactions (events related to user interaction with media) from media activity stubs, the Messenger will perform the following tasks:

1) The module will enhance the information in the transaction by tagging it with the identifiers for user session, user machine, and the current time (S150).

2) The module will enqueue the transaction in an outgoing transaction buffer. There may be other transactions waiting in this buffer, or it may be empty. The new transaction will always be placed at the end of the queue (S155).

3) The module will examine the transaction identifier for the transaction just queued (S160). If it is in a known set of transactions that require immediate post to the server (S165, S175, S185), it will proceed to step 4. If not, the handling is complete for the moment (the transaction will be pushed up via a periodic timed process later) (S170).

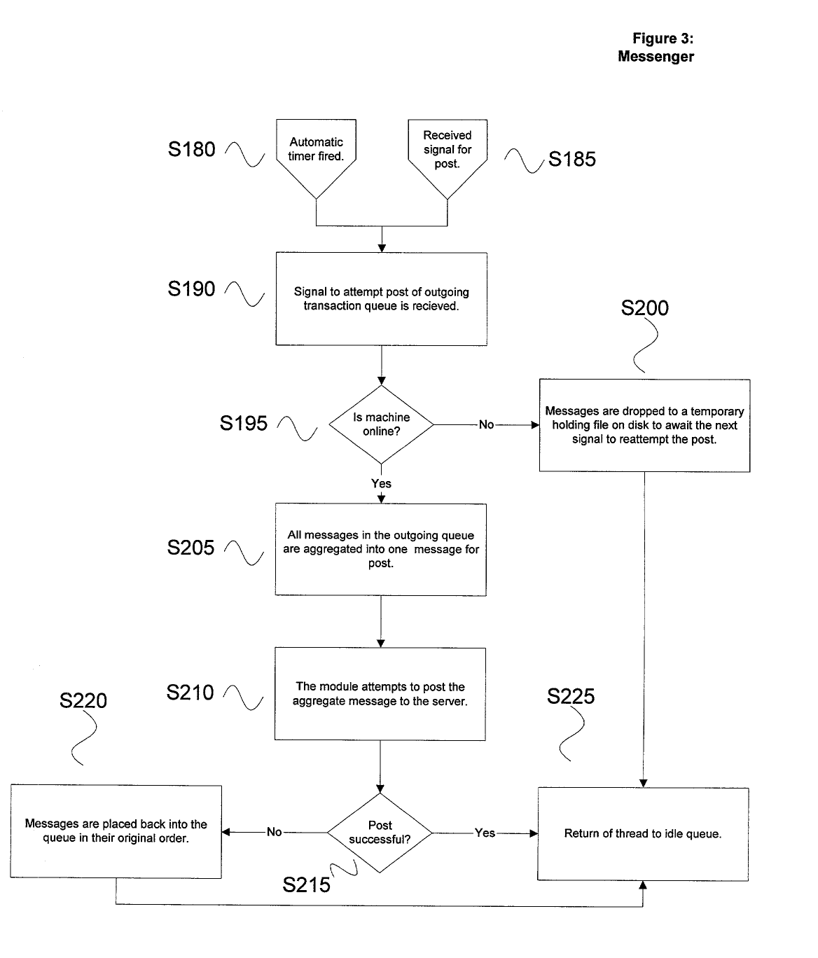

4) The module will determine if the machine is online (FIG. 3, S190, S195). If it is, it will proceed to step 5. If it is not, the transaction will either be pushed up later or buffered to disk by the timed process (S200).

5) The module will take all enqueued transactions and aggregate them into the body of one HTTP POST request (S205). The module then attempts the POST of these transactions (S210). If the POST completes successfully (S215), the handling process is complete (S225). If it fails, the transactions will be again moved into the queue, prepended in original order in front of any transactions that may have been asynchronously added to the queue (S220).

There is a timed periodic process that will always fire if the time from the Messenger's last attempted POST to the server has exceeded a predefined limit (S180). When this occurs, the system will jump directly to step 4 above and attempt to push transactions to the server.

If the user closes the Messenger or the Messenger is told to close by the operating system because the user's machine is shutting down, the Messenger will create a temporary file on the user's machine and move all buffered transactions into the file with a very simple hash. On startup, the Messenger will look for the existence of such a temporary holding file and read out the transaction information in order to recreate the state of the buffered transaction queue. In this manner, the application is able to nicely capture information about user interaction with media while the user's machine is online and it will be pushed up in a single aggregate post the next time the user connects while the application is running.

On the server-side, activities can be viewed as falling into a number of distinct categories. These categories include: activities related to interfacing with external activity reporting systems (such as the Messenger application or a website); activities related to queuing transaction activity for later complete archival, detailed archival and the mechanisms for exporting information for that archival; activities related to the processing of transaction activity, analysis of said activity, and application of information about said activity to a persistent user profile; and activities related to periodic operations performed across all persistent user profiles.

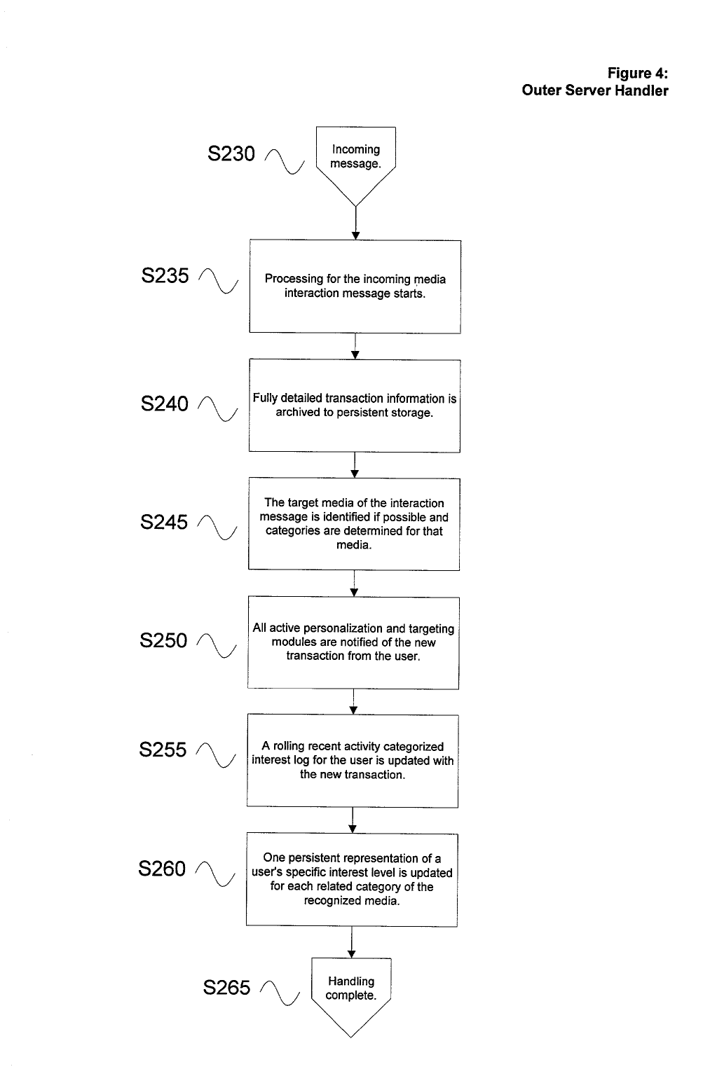

To interface with the server systems (FIG. 4, S230, S235), an external system pushes transactions related with user interaction with media in through one of a variety of interfaces. The interface types involve an HTTP-based POST, Java RMI call, direct method call, or socket push of information. In this way, the profile system can easily accept profile interaction information from a range of sources ranging from videos a user may have watched on a remote machine (captured by the Messenger) to items the user may have searched for on a website (and passed in to the profile system via direct method call). The end result is the same, in that a set of user transaction information is brought into the appropriate handler for dealing with this information. The information should be pushed in via a standardized message format (XML as an example) and each transaction should identify the unique user or user session that the information was captured for, the type of transaction captured, and detailed information for the captured transaction identifying all pieces of captured information about the represented media interaction.

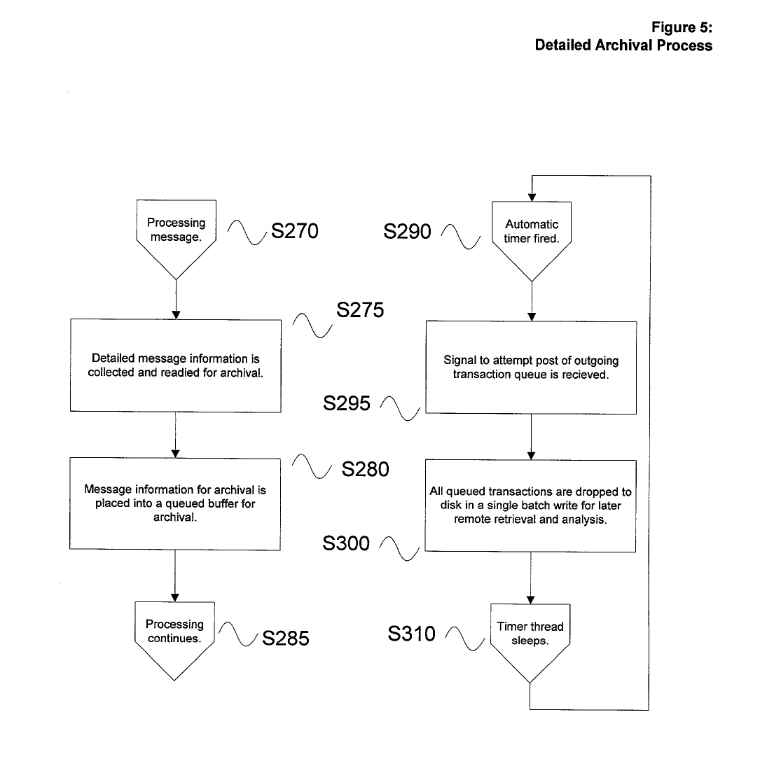

The handler for this type of aggregate transaction information will next pass off each captured transaction to a processing mechanism. This processing mechanism has several stages. The first is to buffer the full and complete set of information contained in the transaction to an in-memory queue (S240, S270-285). This synchronized queue will contain a full period-slice set of detailed transaction information and is holding it in queue for archiving. Periodically, and asynchronous event will fire within the system (FIG. 5, S290) and cause the system to write all of the queued transactions in batch form (S295) to persistent storage such as disk or a database (S300), and will remove all transactions archived in this manner from the queue (S300, S305). Once there, the detailed information is forever available for further analysis or aggregate reporting. The asynchronous nature of the archival queuing means that there is little latency introduced into the actual request handling network process, and that the actual I/O to write the transactions under when the system is accruing transactions at great rate is optimized.

The next step for the processing mechanism is to hand the captured media-interaction transactions to a user profile update module. The purpose of this module is to build and maintain a complex, rich user profile that contains useful information about their past interactions with media. The profile is grouped and arranged in such a way that it can later be used by personalization or targeting systems to derive user “interests” and respond accordingly. The hand-off of these transactions goes through a software transaction distributor mechanism that has been set to look for “high priority” transactions. A transaction considered “high-priority” might be one for which the system needs to see the immediate effect upon a user profile. The priority nature can be found by examining meta-information that came up with the transaction or comparing the transaction identifier with a known set of high-priority transactions.

If the transaction is determined to be high-priority, it is passed directly into the profile update module. If it is not determined to be high-priority, the transaction will placed in the back of a transaction handling queue for asynchronous batch processing at a later time. In this way, the handling process for the majority of captured transactions introduces virtually no latency for the external request. Periodically asynchronous event within the system will fire which will trigger the flush of the transaction holding queue. During this flush process transactions are removed from the queue and passed to the profile update module.

As transactions are passed in to the profile update module, the system will do several things. The set of updates here can be implemented in three ways: all logic can be encoded in the update module and it can potentially push a large number of transaction calls against a database; all logic can be handled within the database itself (via stored procedures or other scripting mechanisms) resulting in a single update to the database; or the logic can be slightly dispersed where primary handling logic lies in profile update module but useful scripting facilities and batch SQL transaction handling reduce the total number of database calls to one. Regardless of how the processing is distributed between the profile update system and procedural calls in the database system, the set of actions taken is the same.

The first action for profile update is going to require that the media the user was interacting with be identified. In order to do this, the profile update system will interface with an external media recognition module. One such module has been created in a very powerful fashion. From a very high level, this module will accept as input XML match definition information and return as output identifiers of the media this match definition refers to. The process by which this happens allows for precise association and weighting of disparate text-based attributes, “fuzzy” phonetic based matching, simple extension to external modules (such as waveform analysis), and supports caching of results.

Input to the media recognition module generally consists of XML. This XML defines all attributes associated with the digital media with which the user was interacting. For instance, when dealing with transactions captured by the Messenger on a client machine, this input might include:

File name of a digital media file

Title information from a media tag

Date of release information from a media tag

Descriptive meta information about the identity of the media

Total play length of the media file

Stream names and identifiers

File location information

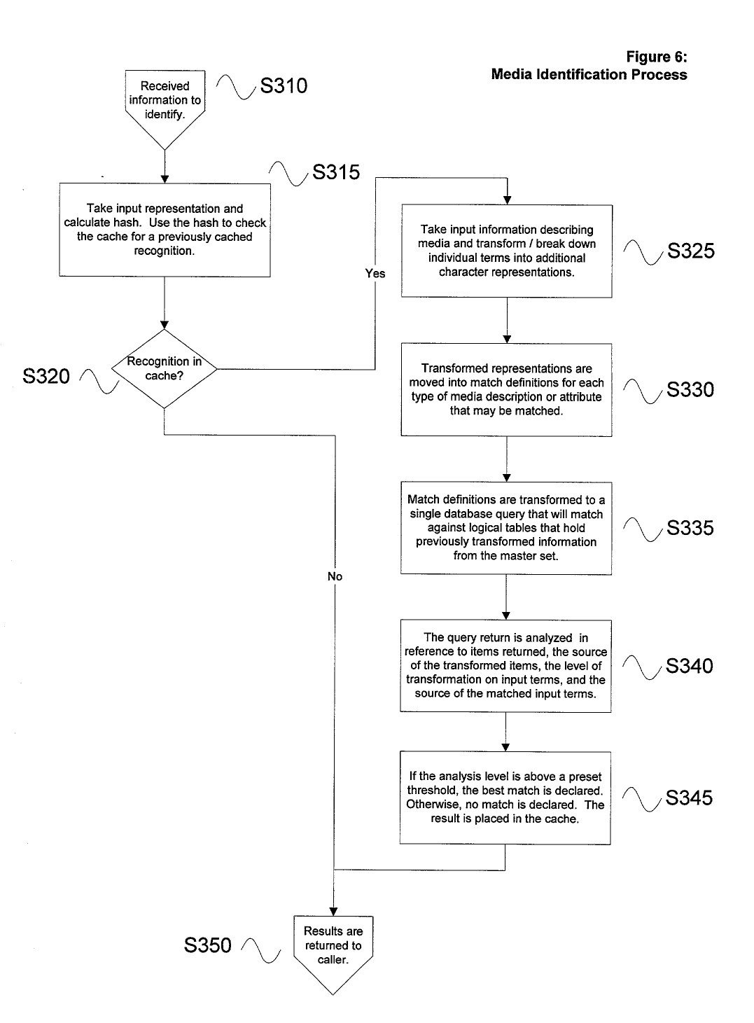

After the XML is submitted to the recognition module, the module will use hooks into a full caching layer within the application server (FIG. 6, S310, S315) to determine if a likely match to this media has already been determined and cached (S320). If so, the rest of the matching process is circumvented and the cached result is immediately returned (S350). The caching footprint of the match information has been optimized and is extremely small: generally under 32 bytes per match and is keyed by a unique hash combination of primary input parameters within the XML.

The XML is then analyzed and pulled into a rule-based system for each piece of disparate information in the definition. These rules define how each individual piece is to be treated, each piece's relative “importance” and “meaning”, and the transformation process for each piece. The rules themselves have been designed to be extended in a simple manner: should new attributes be available to match with, it is a trivial process to extend the module to utilize them.

The transformation process for each piece of recognition data involves breaking text based data into a tree structure by choosing likely term-separation characters and splitting them (S325). The data will be assembled into a tree structure where each successive split will define a finer grain of potential match information and corresponds to another level of depth within the tree. At each node within the tree, potential match information undergoes an additional “soft format” phonetic transformation using a custom algorithm. This transformation will result in a piece of match data that likely “sounds like” the input data (S330). Each node is also given meta-information such as its depth with the tree, term count, total term length, etc.

After the rules have translated and transformed the input XML into the tree-based match definitions, those definitions are passed off to a module that handles interface with the persistent database. This module aggregates and links the information in each tree structure within one another by the type of potential match information, source, and data duplication. It takes the result and builds optimized SQL parameters to pass to a pre-built procedure over JDBC.

The database procedure itself is matching the aggregated data against special match definition tables that have been pre-generated within the data set (S335). The pre-generation process utilizes the same recognition module in order to create a similar set of translated match information in the live database against the existing dataset. The generation set is takes heavy advantage of the a data design system which is able to quickly identify the source data type for a row in a table via examination of only the primary key of the table because of enforced uniqueness constraints. This allows for the actual query to execute in a single-pass against one index for all potential match data types: it therefore is able execute without any full table scans, without any need for sorting or aggregation, and without any table joins. The result is an extremely fast and optimized query.

When the result comes back to the Application Server, the recognition module assembles the match result data and performs a highly optimized single scan to determine the best match (S340). Because of actual data layout, the result scan can be stopped short at any point when the algorithm finds something it considers to be the “best match” (S345). The weighing process is again rules based and makes strong use of hashes against the input definition trees. In this way, the module can easily consider potentially conflicting matches to different pieces of the input XML and score them against one another. In addition, the module will modify the score by determining the individual match strength for each term through a distance calculation from the corresponding input term or terms.

Finally, the module will assemble the media identification for the matched item. For music, this translates to some combination of artist, album, and track identifiers. For video, this translates to some combination of source, provider, and release identifiers. This information is passed back into the caching mechanism and is then returned to the profile update module.

Back in the profile update module, the module is now aware of the identity of the media the user was interacting with. If the matching module was unable to resolve the media at all, the profile update module has completed its work and stops processing for that transaction. The actual details of the transaction (that includes all information about the unmatched detail) will be archived via a process previously described and recognition could be attempted again later.

With recognition information in hand, the profile update module is now free to update the rich user profile for the user for whom the interaction was recorded. The first step of this is to determine the full set of known categorized identification information of the media with which the user interacted (FIG. 4, S245, S250). For audio media, this set of information may include such items as the artist, album, song, and genre of the music. For video media, this set of information may include such items as the movie, genre, director, primary actors, and source of the content.

Next the system will drop a single transactional record representing the transaction in a database table or set of tables that contains a finite set of recent transactions for the user (S255). The transaction record in this table will include the categorized information (or one or more keys that can be used to resolve such information), a reference to the user for whom the interaction was captured, and a reference to the exact type of media interaction captured. By design, the full set of information captured in this way should be a rolling set of the most recent N transactions where N is either a predefined number or is dynamic based upon the frequency of user activity captured by the system. Therefore, the system should periodically or automatically clear any transactions beyond the N most recent out of this repository in order to keep the data footprint low. In this way, this table will represent a snapshot of useful information about recent media interaction by the user.

As the next step, the system will update one or more tables in response to each of the useful categorization types that the system picked out based on the output of the match recognition module (S260). Each table or set of tables to be updated is responsible for keeping enough data to calculate the user's perceived interest in the type of category represented. For instance, the set of “genre” tables for a given user will have enough information so that the system can determine that user's interest in different genres, the reason for the belief that the user is interested in those genres, and how strongly the system believes the user is interested in those genres relative to other genres. To do, a compressed set of information must be stored in these tables to reflect a useful summary of the user's past interaction with the type of category in that table representation. This set of information will typically include a reference to the user, a reference to the type of category the user is interested in, the number of interactions the user has had with the category, the most recent strong interaction the user has had with the category, and an indicator of whether user interest in the category has been increasing or decreasing (as calculated from interest snapshots to be discussed shortly). The user interest of a single item in the category table set relative to other items is something that can be calculated from the set of information being kept about each individual user to category-item relationship. In this way, a complete and extremely useful set of information defining the user's history of interaction with different categories of media is kept. After writing out this information, the user profile update is complete (S265) and the transaction handler can move to the next recorded interaction for processing.

An asynchronous event will fire within the system periodically for purposes of looking over finite sets of recent user activity. This event will calculate relative interest levels for within the most popular category items of media interaction for users over the last finite period. This period before calculation is independent for each user and can either be fixed or can be dynamic with respect to the amount of user activity being captured. When the firing event discovers that the period has expired for a given user, it will calculate the most common items in each category that the user interacted with by examining the recent activity tables in the user profile. It will then create a snapshot of these most recent categories and add that to another profile table. Finally, it will update individual items in the category interaction tables for the user so as to clearly represent whether the user's level of interaction with items is increasing, decreasing, or holding steady. As these snapshot records are yet another compression of the user activity table, they can be kept persistently, expired and deleted on a rolling basis, or go through additional levels of compression. This feature of the profile capture system thus allows the system to clearly understand changes in a user's interest levels with various categorizations of media by compressing captured interaction information.

The preferred embodiments described above have been presented for purposes of explanation only, and the present invention should not be construed to be so limited. Variations on the present invention will become readily apparent to those skilled in the art after reading this description, and the present invention and appended claims are intended to encompass such variations as well.

What is claimed is:

1. A method of processing information, the method comprising:
interfacing with a target application used to play, access, organize, find, or share digital video or audio media;
registering a change of state within the target application;
querying from the application and user environment all known details about the current state of the target application and media it is working with;
sending to another module all queried information in the form of a media interaction state message for processing.

2. The method of claim 1 wherein the change of state is detected.

3. The method of claim 1 wherein the application state and media being acted upon is put into a message body.

4. The method of claim 1 wherein the message is sent to an external module for processing.

5. A method of processing information, the method comprising:
accepting a media interaction state message containing state information about an application used to play, access, or share digital video or audio media;
enhancing the media interaction state message by adding information uniquely identifying the current user session, machine, and time of the message;
pushing the media interaction state message singly or in batch up to a server in a network request;
saving media interaction state messages to disk if the machine is not connected to the network when the message is attempted to be pushed live.

6. The method of claim 5 wherein the media interaction state message is accepted.

7. The method of claim 5 wherein the media interaction state message is enhanced with user session information.

8. The method of claim 5 wherein the media interaction state message or a group of media interaction state messages are pushed up to a network device.

9. The method of claim 5 wherein a queue of unsent media interaction state messages can be saved to disk and will be sent up when it is detected that the user is back online.

10. A method of processing information, the method comprising:
accepting one or more media interaction state messages from client software, a web-serving system, or an external network system;
persistently archiving in full detail the contents of all received media interaction state messages;
identifying the media in a master database that each media interaction state message is a reference to;
notifying personalization and targeting systems of the new user transaction so that they can update and respond appropriately;
determining categorizations of the referenced media;
persistently storing the categorized information to a rolling recent activity log for the user;
updating a persistent, compressed history of each user's interaction with the affected categorization types of the referenced media;

11. The method of claim 10 wherein one or more media interaction state messages are accepted by an interface that can communicate with client software, systems serving web pages, or external systems that are gathering information about user interests and interaction with media.

12. The method of claim 10 wherein the detailed information about captured transactions are buffered and then written out to disk in batch form for later analysis and processing.

13. The method of claim 10 wherein input information that may describe the playing media is broken into component parts and transformed into a common representation.

14. The method of claim 10 wherein transformed information is pushed against a master database of similarly transformed information describing media and the most likely match (if one exists) is determined.

15. The method of claim 10 wherein a rolling set of most recent transactions from users is updated with the information from the media interaction state.

16. The method of claim 10 wherein a rolling set of most recent transactions from users is updated with the information from the media interaction state message including user, transaction type, and categorized information from the identified target media item.

17. The method of claim 10 wherein individual persistent representation of user interests in specific categories is updated by applying the categorized information from the media interaction state message including user, transaction type, and categorized information from the identified target media item.
